(19) United States
(12) Patent Application Publication
(10) Pub. No.: US 2006/0202658 A1
(43) Pub. Date: Sep. 14, 2006

(54) Emergency power source for mobile phones and digital cameras

(76) Inventor: Gunter Andresen, Wedel (DE)

Correspondence Address: Friedrich Kueffner;Suite 910, 317 Madison Avenue, New York, NY, 10017, US

(21) Appl. No.: 11/143,882

(22) Filed: Jun. 1, 2005

(30) Foreign Application Priority Data
Mar. 9, 2005 (DE) 20 2005 003 912.8

(51) Int. Cl. H02J 7/00

(52) U.S. Cl. 320/103

(57) ABSTRACT

The emergency power source such as a battery for mobile phones and digital cameras with a rechargeable current storage unit working on electrochemical base, such as an accumulator, and with a loading jack for the connection of a charging set consists of a closed casing (41) having approximately the size of a half cheque card in the inner space of which at least one, preferably four lithium cells are placed, whereby the lithium cells are connected electrically with a connector plug (60) which comes out on one of the four side walls (42) of the casing (41) which is compatible with the loading jack (30) of the mobile phone (100) or of the digital camera and is handy with smallest dimesions and makes the charging of discharged accumulators in a second, whereby it can also be phoned or digital cameras can be used during the charging procedure.

This invention relates to an emergency power source such as a battery for mobile phones and digital cameras with a rechargeable current storage unit working on electrochemical base, such as an accumulator, and with a loading jack for the connection of a charging set.

A mobile phone depends on a portable electric current supply independent from the electric network. This energy is made available to the mobile phone by a rechargable storage unit, an accumulator. When the accumulator is loaded, the mobile phone can be taken along and used independently from the location. If the energy stored in the accumulator is used up, the accumulator must be filled again. For this charging of the accumulator of a mobile phone which is necessary from time to time, charging sets are used which can be connected to the electric network and which can give electric energy for charging the accumulator on the outlet side over a control electronics. For this purpose, the mobile phone is generally connected with the charging set for a few hours. Standard charging devices have the form of a table loading station into which the mobile telephone can be inserted for the charging process. Besides the table loading station, connection cables from the plug to the mobile telephone for charging the accumulator are known as well.

Mobile telephones are naturally often taken along and used when travelling. For longer travels, the question is that the mobile phone must on the way always be charged again from time to time. So-called quick charging devices or travel charging devices are sold for this purpose. This being, the matter is in principle of standard charging devices of the above mentioned type which draw electric energy from a public electric network. Travel charging devices additionally have an automatic voltage adaptation from 90 to 270 V so that they can be adapted when travelling abroad to the different public voltage levels prevailing there.

Moreover, it is possible for charging mobile phones to connect the mobile phone by an appropriate cable to the battery of a vehicle in order to take the necessary charging energy from there. This being, typically, the coupling with the car battery takes place over the cigarette lighter in the car. The condition for this charging possibility is that a car is available.

The disadvantage of the charging devices for mobile phones mentioned above is that they suppose the accessibility to a public current network or to a car. Thus, for travels for which this possibility is not given, the accumulators of the mobile phone cannnot be charged again and in the end the mobile phone cannot be used. However, the user can try to take along several charged accumulators or batteries, which is however complicated, expensive and always subject to uncertainties.

For the charging of accumulators of mobile phones, different possibilities have been disclosed. The WO 98/42060 A describes a mobile phone with an integrated charging device which consists of a hand-operated dynamo which is actuated by moving a hand key transversely to the longitudinal direction of the mobile phone.

The EP-A-0 409 819 knows a portable end device for communication engineering, i.e. a mobile phone, the current supply of which takes place by means of batteries. For the case that the batteries are used up and that there is no possibility to buy new batteries, the mobile phone is equipped for a battery independent function with a hand dynamo as a current supplying device, however not for the new charging of batteries, in order to guarantee an emergency power supply of the mobile phone. Since the hand dynamo is actuated with muscular power, the service life of the mobile phone is only limited by the staying power of the operating person.

The DE 295 20 719 discloses a device for the recharging of accumulator batteries in relation with the use of the photo and video technique in order to have the devices used in this field continuously ready to use. The electric energy for the charging and/or recharging of the battery accumulators is supposed to be made available by manual actuation. For this purpose, the device consists of a dynamo which is driven by a crank handle, whereby a gear is provided between the crank handle and the dynamo and a rectifier diode between the dynamo and the charging contacts for the accumulator batteries. The contact points are placed directly on the casing in which the dynamo is placed so that the accumulator batteries must be placed upon for the charging procedure. Due to the arrangement of the dynamo and to the gear transmission, an unhandy charging device is created which makes difficult the use in connection with a mobile phone just because of its weight, whereby it must be added that for this known device no control possibility of the charging state of the accumulator batteries is provided. Add to this that this charging device must be operated with both hands since the device must be held in position with one hand and the string drive must be actuated with the other hand. An one-hand operation is not possible.

All these devices for the charging of the accumulators in mobile phones are unhandy, often difficult to operate and cannot always be taken along. If there is no charging device available and if the charging of the accumulator in a mobile phone has been forgotten, the mobile phone is often then not ready to be used.

For the emergency power supply of mobile phones, it is known by the DE 201 19 406 U1 to provide the mobile phones with a replacement accumulator device which consists of an accumulator space and a pluralitiy of replacement accumulators placed in this accumulator space, since this replacement accumulator device is integrated into the casing of the mobile phone, a particular configuration and shaping of the casing of the mobile phone is necessary. The replacement accumulator device thus cannot be used universally for mobile phones.

The DE 201 01 671 U1 discloses an emergency power supply which is not rechargeable for mobile phones; the device provided for this consists of a casing with batteries placed in the inner space thereof, whereby a plug connection is provided for the connection to the mobile phones, whereby the plug can also have an adapter function.

This emergency power supply device can, according to the DE 201 01 659 U1, also be operated with rechargeable batteries.

In adaptation to the respective mobile phone type, the emergency power supply device is provided with a plurality of batteries which correspond to the necessary tension and voltage of the respective mobile phone so that, for example, the owner of several mobile phones of different types must also possess the emergency power supply devices adapted to the respective types since the known emergency power supply devices are not provided with a constant number of batteries which can be automatically loaded down to the respective necessary tension and voltage of the respective mobile phone.

The aim of this invention is to create a handy current source with smallest dimensions for mobile phones and digital cameras with which it is possible to charge discharged accumulators of mobile phones and digital cameras in a second in such a manner that a further temporary use of the mobile phone or of the digital camera is possible whereby the phone or the digital camera can be used during the charging process as well.

Furthermore, with the invention, an emergency power source, i.e. an emergency power device for mobile phones and digital cameras should be created which is provided with a constant number of batteries which can be loaded down to the tension and voltage necessary for the mobile phone or digital camera which is respectively to be supplied so that the voltage and tension of the mobile phone or digital camera to be respectively supplied can be adapted and thus an allround usable emergency power source is created.

This aim is achieved with an emergency power source according to the type described above with the characteristics indicated in claim 1.

An emergency power source configured according to the invention for mobile phones and digital cameras consists of a closed casing having approximately the size of a half cheque card in the inner space of which at least one, preferably four lithium cells are placed, whereby the lithium cells are connected electrically with a connector plug which comes out on one of the four side walls of the casing which is compatible with the loading jack of the mobile phone or of the digital camera.

The casing of the emergency power source has an approximately square shape and a height which corresponds to the height of a lithium cell so that the casing of the emergency power source has the smallest dimensions so that because of this configuration it can be taken along at any time by the user of a mobile phone or of a digital camera. This emergency power source is connected only to the loading jack of the mobile phone or of the digital cmera. The loading procedure begins as soon as the connection is active. Should the accumulator battery be completely discharged, it can last up to 2 minutes before the charging control indication begins to work in the display. However, already after a few seconds, the phone can be used further or the digital camera can be operated. During the charging procedure, it can also be phoned and the digital camera can be operated since, because of the small dimensions of the casing of the emergency power source, the manipulation of the mobile phone is in no way impaired or made difficult during phoning and during the charging procedure, which is also the case for the operation of a digital camera.

The emergency power source with its lithium cells can be used several times until the batteries are used up. An emergency power source which is used up is then recycled in the manner of the normal batteries.

Further advantageous configurations of the invention are the subject of the subclaims.

So, the connecting plug of the emergency power source is configured in such a way that the connecting plug can be brought in electric active connection with corresponding loading jacks of the mobile phones. According to an embodiment, the connecting plug of the emergency power source can be configured as a pin for cylindrical loading jacks. However, it is also possible to connect the connector plug with an adapter which is compatible with the loading jack of a certain mobile phone type or digital camera type, whereby the adapter is replaceable by adapters which are compatible with the loading jacks of other mobile phone type or digital camera types.

The four lithium cells are placed in the inner space of the casing of the emergency power source side by side in two rows and arranged close to each other, whereby the single lithium cells are insulated against each other, namely by the insulating rings 51 which surround the single lithium cells. Due to this arrangement of the lithium cells, the batteries are secured against translation and the casing of the emergency power source can thus have the smallest dimensions.

According to another embodiment of the invention, the casing is provided with an optical tension indicating device for indicating the charging state of the emergency power source. For example a light-emitting diode can be used as optical indicator.

Moreover, the lithium cells are electrically connected with a device which makes possible a charging of the tension and of the voltage in adaptation to the respective tension and voltage of the mobile phone type or digital camera type to be supplied.

The invention will be represented and explained below by means of embodiments for a mobile phone.

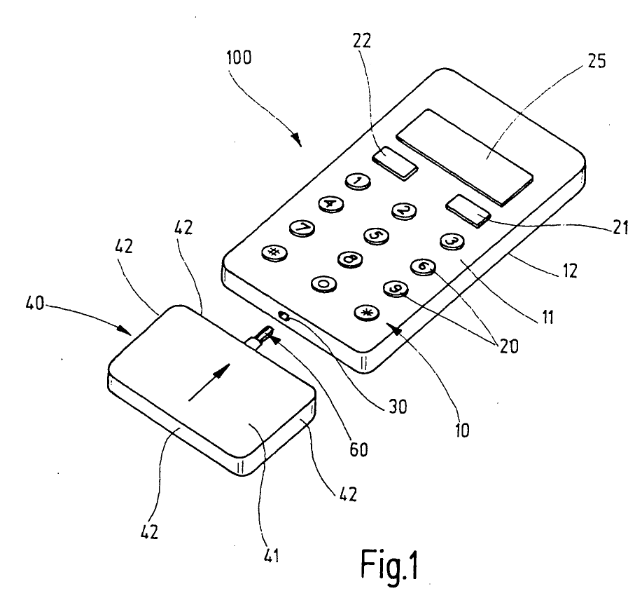

FIG. 1 shows a graphical representation of a mobile phone with an emergency power source in form of a battery before realizing an active electrical connection.

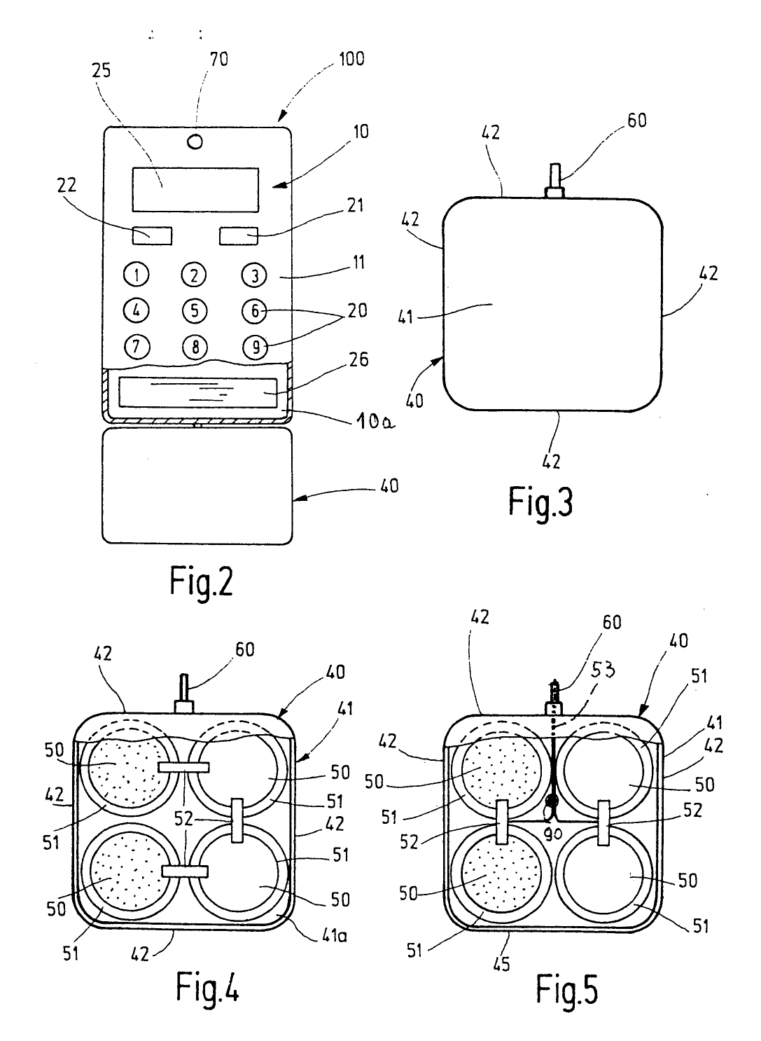

FIG. 2 shows a front view of the casing of the emergency power source in natural size.

FIG. 3 shows the casing of the emergency power source with four lithium cells, partly in front view, partly in horizontal section.

FIG. 4 shows the casing of the emergency power source with four lithium cells, partly in rear view, partly in vertical section.

FIG. 5 shows the casing of the emergency power source with a potential indicating device.

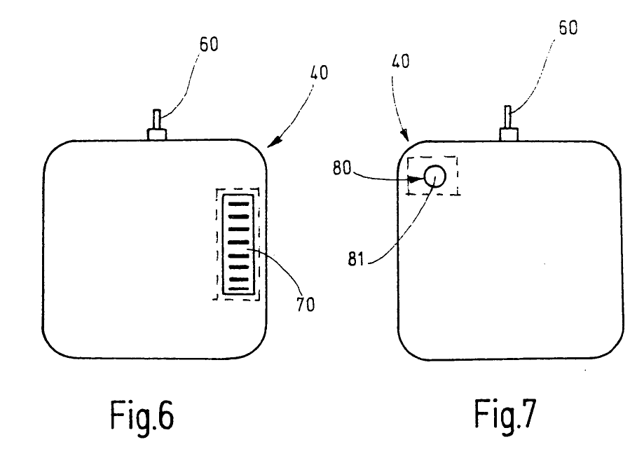

FIGS. 6 and 7 show the casing of the emergency power source with an optical indicating device as a charging control for the batteries in the casing.

The mobile phone 100 represented in FIGS. 1 and 2 consists of a phone casing 10 with the front wall 11, the rear wall 12, actuation keys 20, a switch-on key 21 and a switch-off key 22. Furthermore, a display 25 is provided in the front wall 11 of the phone casing 10. At least one rechargeable accumulator battery 26 which is electrically connected with a loading jack 30 is placed in the inner space 10a of the phone casing 10. The mobile phone is otherwise configured in a manner known in itself.

An emergency power source 40 which constitutes an autonomous element and which is not a fixed integrated constituent of the mobile phone is provided for charging the accumulator battery 26 in the mobile phone 100.

This emergency power source 40 consists of a casing 41 with the side walls 42 and with lithium cells 50 placed in the inner space 41a of the casing 41. The casing 41 has the size of approximately half a cheque card and is configured completely closed (FIGS. 1, 2 and 3). The casing 41 of the emergency power source 40 represented in FIG. 3 has a normal size and, for this reason, is easy to manipulate and to take with. The height of the casing 41 corresponds approximately to the height of a lithium cell.

At least two, for the embodiment represented here preferably four lithium cells 50 are placed in the inner space 41a of the casing 41 whereby, depending on the respective performance of a lithium cell, a single lithium cell can also be used.

Each lithium cell 50 is surrounded with an annular insulation 51 of an appropriate synthetic material so that there cannot be any direct contact between the lithium cells 50 with each other in the inner space 41a of the casing 41.

The lithium cells 50 are electrically connected with a connecting plug 60 which comes out from one of the four side walls 42 of the casing, this plug being compatible with the loading jack 30 of the mobile phone. Due to the approximately square configuration of the casing 41, the casing 41 adapts itself in charging state approximately to that of the mobile phone 100. The height of the casing 41 corresponds to the height of a lithium cell 50.

The lithium cells 50 are necessarily connected with each other over connecting contacts 52, as represented in FIGS. 4 and 5. The connecting contacts 52 are connected over electrical feeding lines 52 with the connecting jack 60 (FIG. 5).

The connecting plug 60 of the casing 41 of the emergency power source 40 is configured in such a manner that the connecting plug 60 can be electrically actively connected with the loading jacks of the mobile phones (FIG. 2).

As represented in the figures, the connecting plug 60 is configured in the manner of a pin for cylindrical loading jacks 30. In order to be able to insert a connecting plug 60 configured in this manner into differently configured loading jacks as well, the connecting plug 60 can be connected with an adapter which is compatible with the loading jack of a certain mobile phone type, whereby the adapter can be replaceable, namely by adapters which can be connected with the loading jacks of other mobile phone types.

The four lithium cells 50 in the inner space 41a of the casing 41 are placed side by side in two rows, as representend in FIGS. 2 and 3, and arranged close to each other, whereby the single lithium cells are insulated against each other, namely by the insulating rings 51 which surround the single lithium cells. Due to this arrangement of the lithium cells 50 in the inner space 41a of the casing 41, a compact construction of the casing 41 is obtained and moreover it is achieved that the lithium cells are secured against translation in the casing inner space.

The lithium cells 50 are connected with an electrical tension/voltage adaptation device 90, such as a resistor or the like, so that the lithium cells can be loaded down to the tension and voltage of the mobile phone which is respectively to be supplied. This electrical device can be actuated for example manually in order to be able to adjust the necessary tension (FIG. 5).

For the embodiment shown in FIG. 6, the casing 41 of the emergency power source 40 is provided with an optical tension/voltage state indicating device 70 for indicating the respective charging state of the emergency power source. For checking the respective tension, an optical indicating device 80 can also be provided in the casing 41 which can be configured, for example, as a light emitting diode 81 which is placed on the front wall of the casing 41 (FIG. 7).

### LIST OF REFERENCE NUMERALS

φMobile phone
10 Phone casing
10a Innerspace
11 Front wall
12 Rear wall
20 Actuation keys
21 Switch-on key
22 Switch-off key
25 Display
26 Rechargeable accumulator
30 Loading jack
40 Emergency power source
41 Casing
41a Innerspace
42 Side walls
50 Lithium cells
51 Insulating rings
52 Connecting contacts
53 Feeding line
60 Connecting plug
51 as a pin
70 Tension/voltage state indicating device
80 Optical battery charging state indicating device
81 Light emitting diode
90 Tension/voltage adaptation device

1. Emergency power source (40) such as a battery for mobile phones (100) and digital cameras with a rechargeable current storage unit working on electrochemical base, such as an accumulator, and with a loading jack (30) for the connection of a charging set, wherein the emergency power source (40) consists of a closed casing (41) having approximately the size of a half cheque card in the inner space (41a) of which at least one, preferably four lithium cells (50) are placed, whereby the lithium cells (50) are connected electrically with a connector plug (60) which comes out on one of the four side walls (42) of the casing (41) which is compatible with the loading jack (30) of the mobile phone (100) or of the digital camera.

2. Emergency power source according to claim 1, wherein the casing (41) of the emergency power source (40) has a square form and a height which corresponds to the height of a lithium cell (50).

3. Emergency power source according to claim 1, wherein the connecting plug (60) of the emergency power source (40) is configured in such a way that the connecting plug (60) can be electrically actively connected with corresponding loading jacks (30) of the mobile phones or digital cameras.

4. Emergency power source according to claim 1, wherein the connecting plug (60) of the emergency power source (40) is configured as a pin (41) for cylindrical loading jacks (30).

5. Emergency power source according to claim 4, wherein the connecting plug (60) can be connected with an adapter which is compatible with the loading jack (30) of a certain mobile phone type or digital camera type, whereby the adapter is replaceable by adapters which hare compatible with the loading jacks (30) of other mobile phone types or digital camera types.

6. Emergency power source according to claim 1, wherein the four lithium cells (50) are placed in the inner space (41a) of the casing (41) side by side in two rows and arranged close to each other, whereby the single lithium cells (50) are insulated against each other by means of insulating rings (51).

7. Emergency power source according to claim 1, wherein the lithium cells (50) can be loaded down to the respectively necessary tension and voltage of the mobile phone or digital camera to be supplied by means of an electric tension/voltage adaptation device (90) such as a resistor.

8. Emergency power source according to claim 1, wherein the casing (41) of the emergency power source (40) is provided with an optical battery charging state indicating device (80) for indicating the charging state of the emergency power source (40).

9. Emergency power source according to claim 8, wherein a light emitting diode (81) is provided as optical battery charging state indicating device (80).
